(19) United States
(12) Patent Application Publication
(10) Pub. No.: US 2008/0282284 A1
(43) Pub. Date: Nov. 13, 2008

(54) Method and Apparatus For Utilizing a Broadcast Flag

(75) Inventors: Bjoern Kaag, Heerlen (NL); Martin Freeman, Palo Alto, CA (US); Hendrik Frank Moll, Geldrop (NL); Erik de Meersman, Snellegem (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,999

(22) PCT Filed: Dec. 5, 2005
(86) PCT No.: PCT/IB2005/054050

§ 371 Date: Dec. 20, 2006

Related U.S. Application Data
(60) Provisional application No. 60/633,617, filed on Dec. 6, 2004.

(51) Int. Cl. H04N 7/167; H04L 9/00

(52) U.S. Cl. 725/31; 380/255

(57) ABSTRACT

There are provided apparatus and methods for controlling distribution of data from a first device to a second device. One such apparatus includes a broadcast flag detector and a data manipulation device (106). The broadcast flag detector is for detecting one or more portions of the data associated with an enabled broadcast flag (BF). The data manipulation device (106) is for manipulating the one or more portions so as to render the one or more portions of the data useable in the first device only upon further manipulation and so as to render the one or more portions of the data permanently unusable in the second device.

This disclosure generally relates to media content and, more particularly, to methods and apparatus for controlling the distribution of data from a first device to a second device utilizing a broadcast flag. Such control may include, but is not limited to rendering the data unusable and/or inaccessible.

The Federal Commission for Communication (FCC) proposed the “Report and Order and Further Notice of Proposed Rulemaking”, FCC 03-273, on Nov. 11, 2003, relating to the broadcast flag (BF) that is to take effect on Jul. 1, 2005. Starting from the effective date, no OpenCable device (e.g., a television, a set top box, etc.) is allowed to pass received Audio Video (i.e., AV) broadcast content via the mandatory host point of deployment (pod) interface when that content is marked with a so-called broadcast flag. All such devices must detect the broadcast flag and act accordingly.

The recent broadcast flag ruling of the FCC requires that digital televisions (DTVs) processing in-the-clear content (i.e., unscrambled content) having a broadcast flag attached must prevent that content from being delivered to the Internet. It specifically requires that such content not pass across user-accessible buses in the DTV. The Motion Picture Association of America (MPAA) states that the POD standards Personal Computer Memory Card International Association (PCMCIA) interface between the host and the POD is also an unprotected and user accessible bus. According to this view, the packets belonging to virtual channels indicated by an enabled broadcast flag may not pass the interface.

Accordingly, it would be desirable and highly advantageous to have apparatus and methods for utilizing a broadcast flag that do not allow received Audio Video (i.e., AV) broadcast content to pass via the mandatory host POD interface when that content is marked with a broadcast flag.

These and other drawbacks and disadvantages of the prior art are addressed by the present disclosure, which is directed to methods and apparatus for controlling the distribution of data from a first device to a second device utilizing a broadcast flag.

According to an embodiment, there is provided an apparatus for controlling distribution of data from a first device to a second device. A broadcast flag detector is for detecting one or more portions of the data associated with an enabled broadcast flag (BF). A data manipulation device is for manipulating the one or more portions so as to render the one or more portions of the data useable in the first device only upon further manipulation and so as to render the one or more portions of the data permanently unusable in the second device.

According to another embodiment, there is provided an apparatus for controlling distribution of data from a first device to a second device. A divider is for dividing the incoming bitstream into at least a first bitstream and a second bitstream. A data manipulation device is for removing, from the first bitstream, packets not located on packet identifiers (PIDs) associated with an enabled broadcast flag (BF), and for manipulating, from the second bitstream, other packets located on the PIDs associated with the enabled BF so as to render the manipulated packets unusable. A clock speed increaser is for increasing a clock speed between the first device and the second device. The data manipulation device inserts at least some remaining packets from the first bitstream and the second bitstream, respectively, into a reconstructed bitstream that reconstructs the incoming bitstream for sending to the second device. The at least some of the remaining packets are inserted at intervals corresponding to the increased clock speed.

According to yet another embodiment, there is provided an apparatus for controlling data distribution from a first device to a second device. A broadcast flag detector is for detecting one or more data packets associated with an enabled broadcast flag (BF) from within an incoming bitstream. A duplicator is for receiving and duplicating the incoming bitstream to provide a first duplicate and a second duplicate of the incoming bitstream. The first duplicate is an identical duplicate of the incoming bitstream. The second duplicate is duplicated so that packets identified by the enabled BF are unusable. The duplicator further is for sending the second duplicate to the second device. A selector, operatively coupled to the duplicator, is for receiving both the first duplicate and the second duplicate from the second device and for selecting only one of the first duplicate and the second duplicate based on a selected virtual channel.

According to still another embodiment, there is provided an apparatus for controlling distribution of data from a first device to a second device. A divider is for dividing an incoming bitstream into at least a first stream and a second stream. A data manipulation device is for rendering unusable, from the first bitstream, packets not located on packet identifiers (PIDs) associated with an enabled broadcast flag (BF), and for rendering unusable, from the second bitstream, other packets located on the PIDs associated with the enabled BF. A joiner is for selecting remaining packets from the first bitstream and the second bitstream to form another bitstream that is a reconstruction of the incoming bitstream for sending to the second device. The remaining packets selected from the first bitstream are respectively located on a PID associated with the enabled BF and the remaining packets selected from the second bitstream are respectively located on a PID not associated with the enabled BF.

According to a further embodiment, there is provided, in a first device, a method for controlling distribution of data from the first device to a second device. One or more portions of the data associated with an enabled broadcast flag (BF) are detected. The one or more portions are manipulated so as to render the one or more portions of the data useable in the first device only upon further manipulation and so as to render the one or more portions of the data permanently unusable in the second device.

According to an additional embodiment, there is provided, in a first device, a method for controlling distribution of data from the first device to a second device. The incoming bitstream is divided into at least a first bitstream and a second bitstream. From the first bitstream, packets not located on packet identifiers (PIDs) associated with an enabled broadcast flag (BF) are removed. From the second bitstream, other packets located on the PIDs associated with the enabled BF are manipulated so as to render the manipulated packets unusable. A clock speed between the first device and the second device is increased. At least some remaining packets from the first bitstream and the second bitstream are respectively inserted into a reconstructed bitstream that reconstructs the incoming bitstream for sending to the second device. The at least some of the remaining packets are inserted at intervals corresponding to the increased clock speed.

According to a still further embodiment, there is provided, in a first device, a method for controlling data distribution from the first device to a second device. One or more data packets associated with an enabled broadcast flag (BF) are detected from within an incoming bitstream. The incoming bitstream is received and duplicated to provide a first duplicate and a second duplicate of the incoming bitstream. The first duplicate is an identical duplicate of the incoming bitstream. The second duplicate is duplicated so that packets identified by the enabled BF are unusable. The second duplicate is sent to the second device. Both the first duplicate and the second duplicate are received from the second device and only one of the first duplicate and the second duplicate is selected based on a selected virtual channel.

According to a yet further embodiment, there is provided in a first device, a method for controlling distribution of data from the first device to a second device. An incoming bitstream is divided into at least a first stream and a second stream. From the first bitstream, packets not located on packet identifiers (PIDs) associated with an enabled broadcast flag (BF) are rendered unusable. From the second bitstream, other packets located on the PIDs associated with the enabled BF are rendered unusable. Remaining packets from the first bitstream and the second bitstream are selected to form another bitstream that is a reconstruction of the incoming bitstream for sending to the second device. The remaining packets selected from the first bitstream are respectively located on a PID associated with the enabled BF and the remaining packets selected from the second bitstream are respectively located on a PID not associated with the enabled BF.

These and other aspects, features and advantages of the present disclosure will become apparent from the following detailed description of exemplary embodiments, which is to be read in connection with the accompanying drawings.

This disclosure will present in detail the following description of preferred embodiments with reference to the following figures wherein:

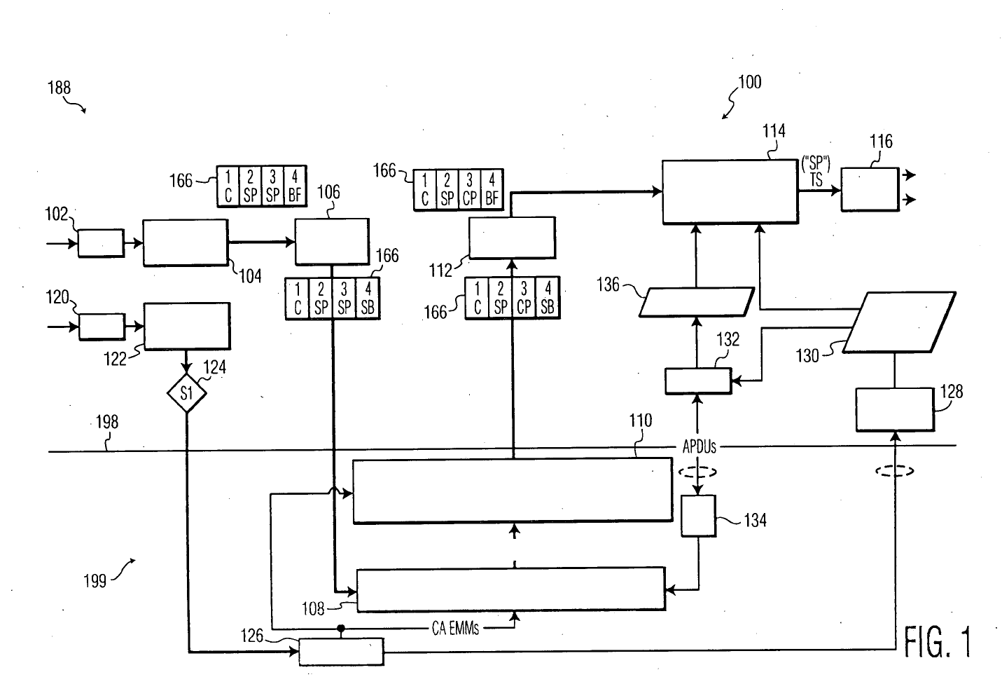

FIG. 1 is a block diagram illustrating an apparatus 100 for controlling the distribution of data having an enabled broadcast flag (BF) associated therewith from a first device to a second device, according to an illustrative embodiment;

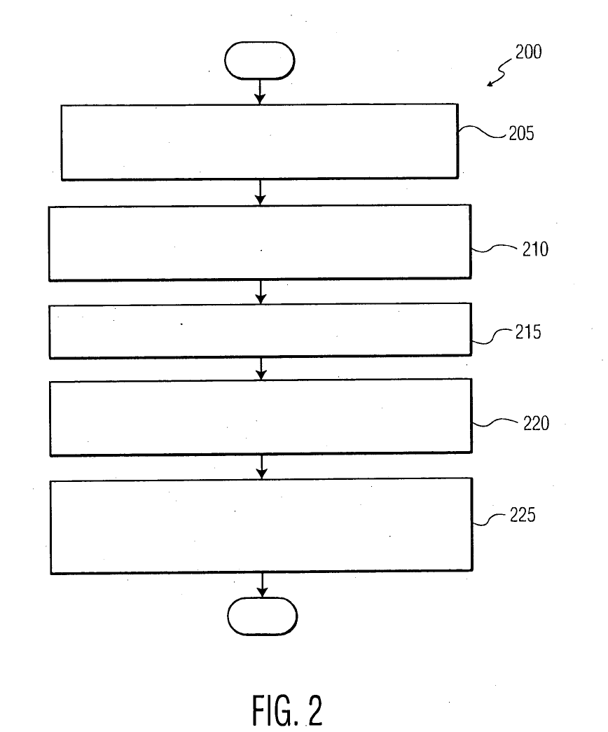

FIG. 2 is a flow diagram illustrating a method 200 for controlling the distribution of data having an enabled broadcast flag (BF) associated therewith from a first device to a second device, according to an illustrative embodiment;

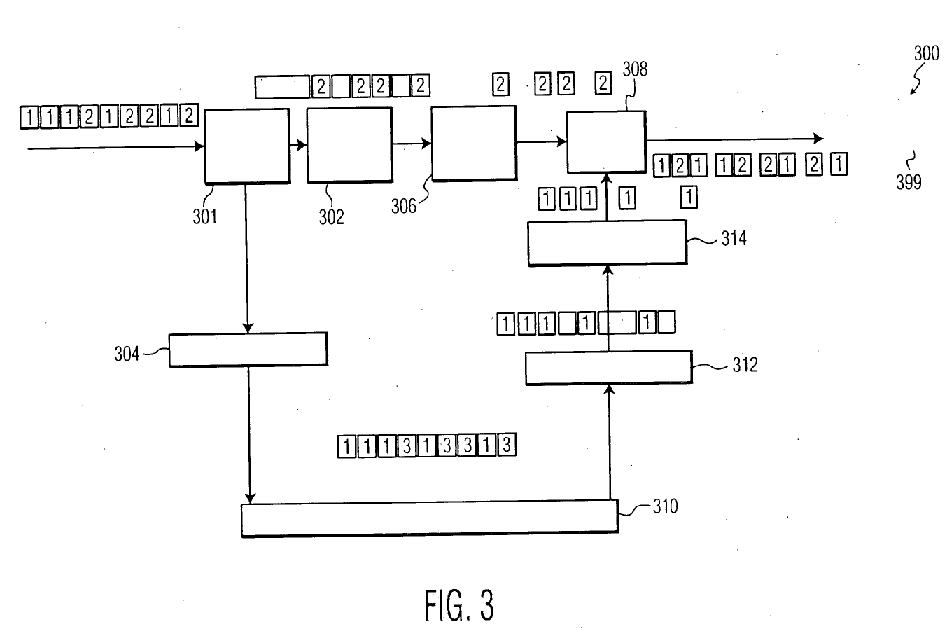

FIG. 3 is a block diagram illustrating an apparatus 300 for controlling the distribution of data having an enabled broadcast flag (BF) associated therewith from a first device to a second device, according to another illustrative embodiment;

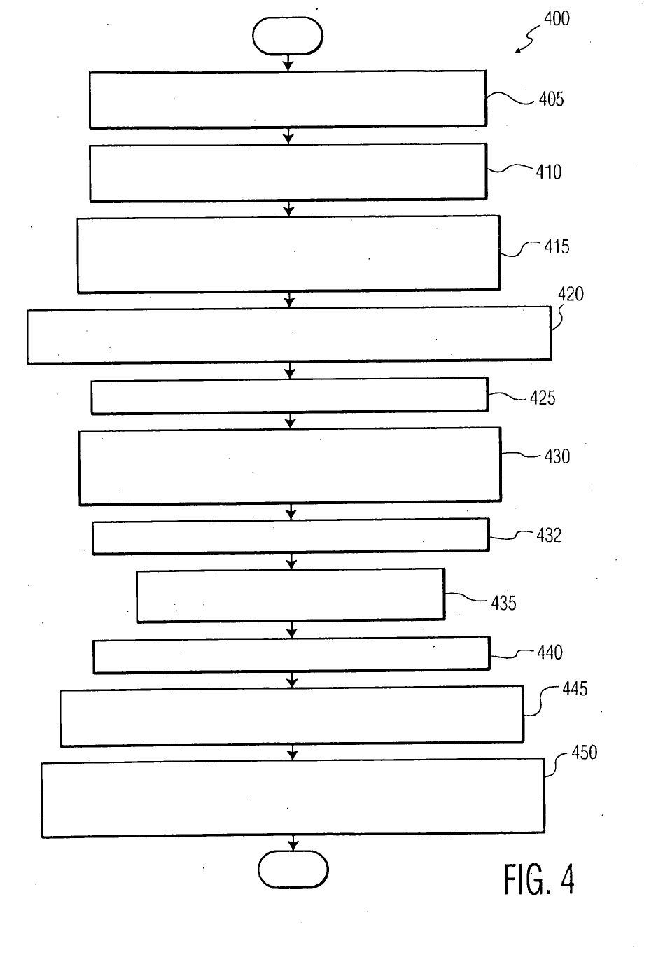

FIG. 4 is a flow diagram illustrating a method 400 for controlling the distribution of data having an enabled broadcast flag (BF) associated therewith from a first device to a second device, according to another illustrative embodiment;

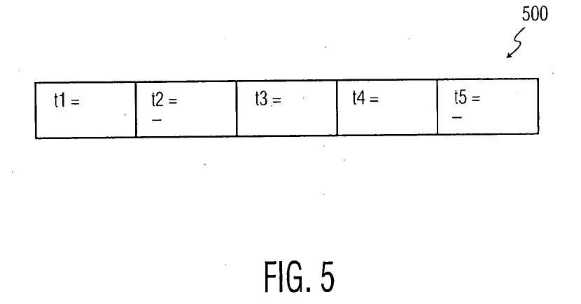

FIG. 5 is a diagram illustrating an exemplary sample “reconstructed” transport stream 500, according to an illustrative embodiment;

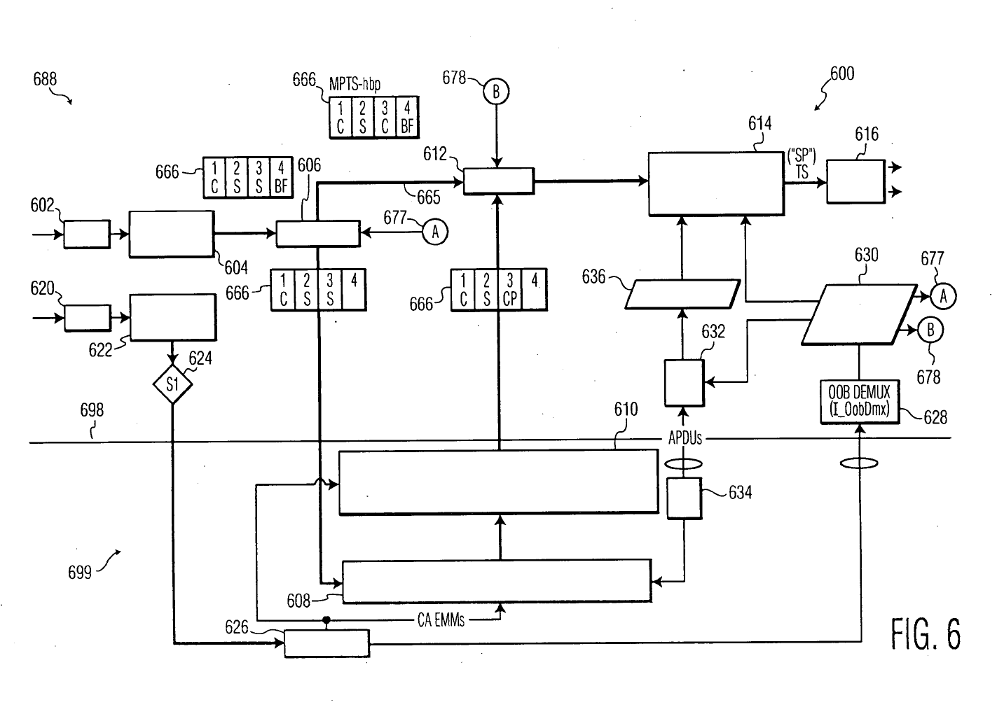

FIG. 6 is a block diagram illustrating an apparatus 600 for controlling the distribution of data having an enabled broadcast flag (BF) associated therewith from a first device to a second device, according to yet another illustrative embodiment;

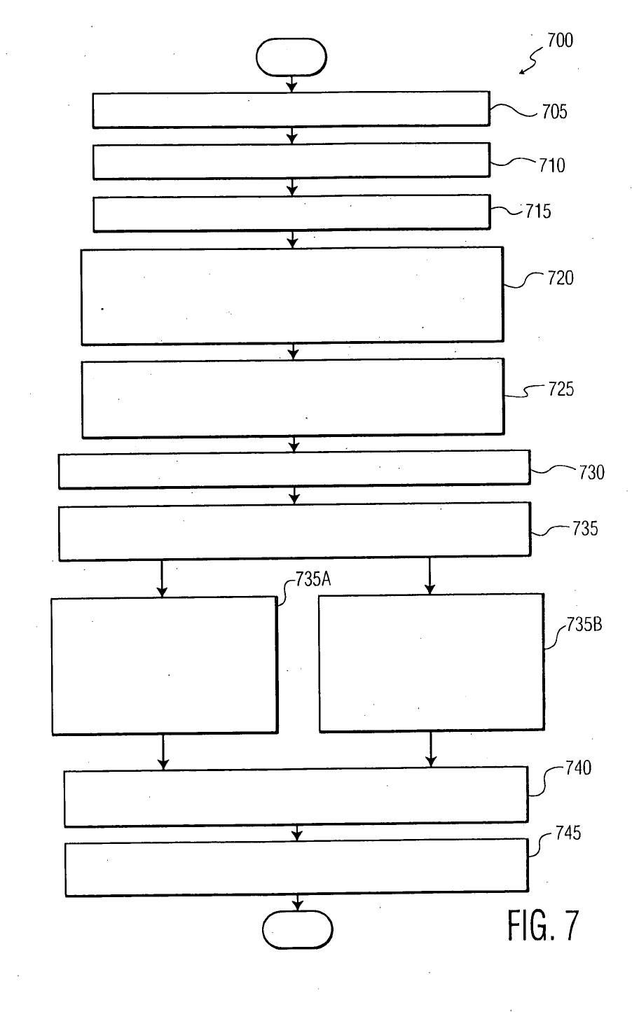

FIG. 7 is a flow diagram illustrating a method 700 for controlling the distribution of data having an enabled broadcast flag (BF) associated therewith from a first device to a second device, according to yet another illustrative embodiment;

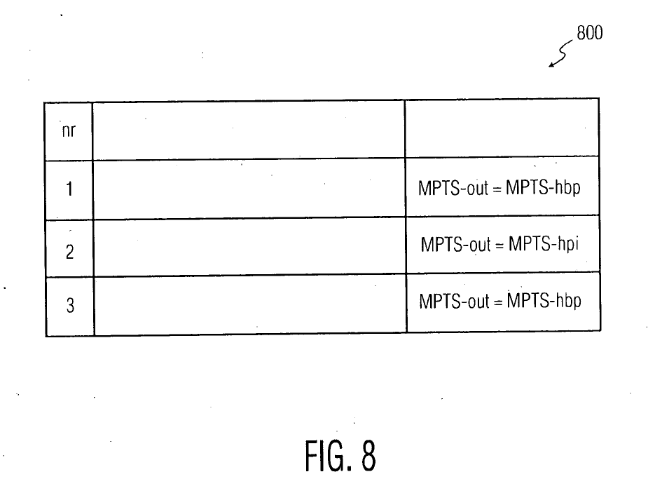

FIG. 8 is a block diagram illustrating exemplary rules for the selector 612 of FIG. 6, according to an illustrative embodiment;

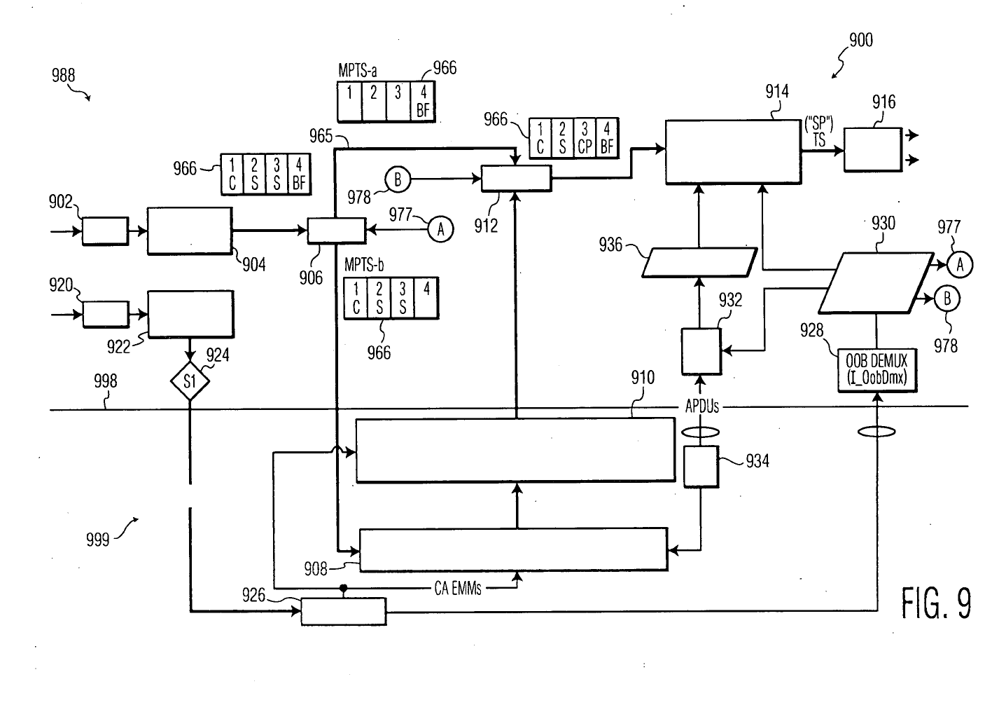

FIG. 9 is a block diagram illustrating an apparatus 900 for controlling the distribution of data having an enabled broadcast flag (BF) associated therewith from a first device to a second device, according to a further illustrative embodiment; and

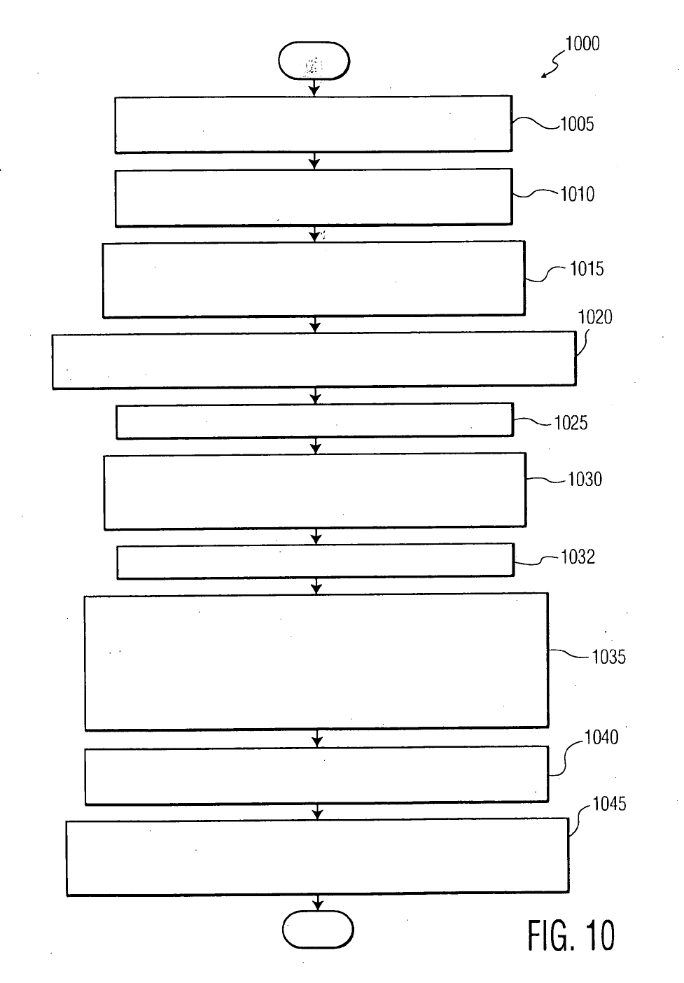

FIG. 10 is a flow diagram illustrating a method 1000 for controlling the distribution of data having an enabled broadcast flag (BF) associated therewith from a first device to a second device, according to a further illustrative embodiment.

The present disclosure is directed to methods and apparatus for controlling the distribution of data from a first device to a second device utilizing a broadcast flag.

Advantageously, the present disclosure provides a novel apparatus and methods for banning or otherwise rendering unusable broadcast flagged packets from the host point of deployment (pod) interface. The present disclosure provides a packet-based approach, in contrast to the stream-based approach that has been proposed by the CEA. The stream-based approach of the prior art does not solve the use of “mixed” MPTS-ses where there exists both scrambled and clear programs (i.e., virtual channels) in the same multiplex. Mixed MPTS-ses are widely used. Advantageously, the present disclosure also supports mixed MPTS-ses.

It is to be appreciated that the present disclosure can be utilized in every device that receives AV content per broadcast over terrestrial or cable, such as a TV set, a set top box, and/or integrated circuits. It is to be further appreciated that as used herein, the words “data” and “content” are used interchangeably.

Moreover, it is to be appreciated the terms scrambling, stuffing and similar terms used herein are all directed to rendering the corresponding data unusable. The method/approach for rendering that corresponding data unusable includes, but is not limited to, scrambling, shifting, stuffing with pre-determines values, XOR-ing, hiding, deleting, and nullifying.

Further, when reference is made herein to a broadcast flag, such reference is intended to specifically refer to an enabled broadcast flag.

The present description illustrates the principles of the present invention. It will thus be appreciated that those skilled in the art will be able to devise various arrangements that, although not explicitly described or shown herein, embody the principles of the invention and are included within its spirit and scope.

All examples and conditional language recited herein are intended for pedagogical purposes to aid the reader in understanding the principles of the invention and the concepts contributed by the inventor to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function regardless of structure.

Thus, for example, it will be appreciated by those skilled in the art that the block diagrams presented herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown. It is to be appreciated that the order of the method steps may be varied, as readily determined by one of ordinary skill in the related art.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means that can provide those functionalities as equivalent to those shown herein.

FIG. 1 is a block diagram illustrating an apparatus 100 for controlling the distribution of data having an enabled broadcast flag (BF) associated therewith from a first device to a second device, according to an illustrative embodiment. FIG. 2 is a flow diagram illustrating a method 200 for controlling the distribution of data having an enabled broadcast flag (BF) associated therewith from a first device to a second device, according to an illustrative embodiment.

Referring to FIG. 1, the first device is a host device (hereinafter “host”) 188 and the second device is a POD device (hereinafter “POD”) 199. The host 188 and the POD 199 are connected in signal communication with each other via a host POD interface 198. The POD 199 includes a POD descrambler 108, a POD CP scrambler 110, a POD OOB mac 126, and a POD CPU 134. The host 188 includes the remaining components. The apparatus 100 may be implemented in one or more of any of the elements of the POD 199 and the host 188, as described by the steps of the method of FIG. 2. Of course, the present invention is not limited to the elements and corresponding configuration (e.g., connections, and so forth) shown in FIG. 1 and, thus, other elements and configurations thereof may also be employed in accordance with the present invention while maintaining the spirit of the present invention. Various MPTS's 166 in various states/configurations are also shown in FIG. 1.

A first input of the host 188 is connected in signal communication with an input of a tuner 102. A second input of the host 188 is connected in signal communication with an input of a tuner 120. A first (RGB) output of the host 188 is connected in signal communication with a first output of the MPEG decoder 116. A second (audio) output of the host 188 is connected in signal communication with a second output of the MPEG decoder 116.

An output of the tuner 102 connected in signal communication with an input of a demodulator (QAM) 104. An output of the demodulator 104 is connected in signal communication with an input of a BF scrambler 106. An output of the BF scrambler 106 is connected in signal communication with a first input of the POD descrambler 108. An output of the POD descrambler 108 is connected in signal communication with a first input of the POD Copy Protection (CP) scrambler 110. An output of the POD CP scrambler 110 is connected in signal communication with an input of a BF descrambler 112. An output of the BF descrambler 112 is connected in signal communication with a first input of a demultiplexer and descrambler 114. An output of the demultiplexer and descrambler 114 is connected in signal communication with an input of an MPEG decoder 116.

An output of the tuner 120 is connected in signal communication with an input of a demodulator (QPSKrx) 122. An output of the demodulator 122 is connected in signal communication with an input of a switch 124. An output of the switch 124 is connected in signal communication with an input of the POD OOB mac 126. A first output of the POD OOB mac 126 is connected in signal communication with a second input of the POD descrambler 108 and with a second input of the POD CP scrambler 110. A second output of the POD OOB mac 126 is connected in signal communication with an input of an OOB demultiplexer 128. An output of the OOB demultiplexer 128 is connected in signal communication with an input of program selection middleware 130. A first output of program selection middleware 130 is connected in signal communication with a host CPU 132. The host CPU 132 is connected in signal communication with the POD CPU 134. An output of the POD CPU 134 is connected in signal communication with a third input of the POD descrambler 108. An output of the host CPU 132 is connected in signal communication with an input of a POD CP 136. An output of the POD CP 136 is connected in signal communication with a second input of the demultiplexer and descrambler 114. A second output of the program selection middleware 130 is connected in signal communication with a third input of the demultiplexer and descrambler 114.

Referring to FIG. 2, a multiprogram transport stream (MPTS-in) is received from a broadcasting network (not shown) and is parsed to obtain the packet identifiers (PIDs) of the elementary streams that are associated with the BF by parsing the PMTs for any redistribution control (RC) descriptors (step 205). All packets belonging to PIDs that are associated with a broadcast flag (BF) are scrambled with a secret scrambling protocol by the BF scrambler 106, thereby changing the channel from type “clear with BF enabled” to “BF scrambled” (step 210). If a selected virtual channel (or a set of selected virtual channels) is scrambled with a matching proprietary network CA system, then only that selected virtual channel (or set of selected virtual channels) is descrambled by the POD descrambler 108 (step 215). The POD descrambler 108 does not descramble the “scrambled BF” channels. The scrambling from the BF flagged channels is only removed by the BF descrambler 112, thereby changing the type of the channel (content) from “BF scrambled” to “clear with BF enabled (step 220). The demultiplexer and descrambler 114 can demultiplex any channel that is in the clear, be it a channel of type “fully clear” or “clear with BF enabled”. The demultiplexer and descrambler 114 can of course also descramble and demultiplex the channels that were re-scrambled by the POD CP scrambler 110. Thus, the demultiplexer and descrambler 114 demultiplexes and descrambles a channel of any of the types of “fully clear” and “clear with BF enabled”, and/or a channel that was re-scrambled by the POD CP scrambler 110 (step 225)

Thus, the method of FIG. 2 renders the BF packets unusable before they reach the POD module 199. The program selection middleware 130 selects a channel that was scrambled by the proprietary CA system of the broadcasting network (e.g., virtual channel 3). The POD 108 will descramble virtual channel 3 and apply the POD CP scrambling 110. The POD CP scrambling is then removed by the host demultiplexer and descrambler 114. All BF enabled transport packets are fully readable by the host demultiplexer, and are only made unreadable (i.e., scrambled) when they cross the host POD interface 198.

It is to be appreciated that the present invention renders the broadcast flag enabled packets unusable by steps including, but not limited to, scrambling, shifting, XOR-ring, and so forth.

FIG. 3 is a block diagram illustrating an apparatus 300 for controlling the distribution of data having an enabled broadcast flag (BF) associated therewith from a first device to a second device, according to another illustrative embodiment. FIG. 4 is a flow diagram illustrating a method 400 for controlling the distribution of data having an enabled broadcast flag (BF) associated therewith from a first device to a second device, according to another illustrative embodiment.

An input of the apparatus 300 is connected in signal communication with an input of a divider and parser 301. An output of the divider and parser is connected in signal communication with an input of a non-BF packet remover 302 and with an input of a BF packet stuffer 304. An output of the non-BF packet remover 302 is connected in signal communication with an input of a clock speed doubler 306. An output of the clock speed doubler 306 is connected in signal communication with a first input of a packet inserter 308. An output of the apparatus 300 is connected in signal communication with an output of the packet inserter 308.

An output of the BF packet stuffer 304 is connected in signal communication with an input of a POD 310. An output of the POD 310 is connected in signal communication with an input of a BF packet remover 312. An output of the BF packet remover is connected in signal communication with a clock speed doubler 314.

It is to be appreciated that while the divider and parser 301 is shown as a single element, in other embodiments the functions performed thereby may be implemented by two elements.

In one illustrative embodiment of the present invention, the clock speed is increased (e.g., including, but not limited to doubling) between the POD controller 310 and the demultiplexer 399 from 5 MHz to 10 MHz. A data enable between DV1_VALID on the demultiplexer 399 and the POD controller 310 will reduce the demultiplexer HW IRQ load to levels of the pre-BFM situation.

Thus, as an example, the packet inserter 308 could receive the following in time: BF packet from host bypass (hbp) at, e.g., t1+t2; and POD packet from POD pass-through (hpi′) at, e.g., t3. In this scenario, the clock between the POD controller 310 and the demultiplexer 399 is doubled from 5 MHz to 10 MHz so that odd can be used for hbp packets and even can be used for hpi′ packets in the “reconstructed” transport stream. Data enable/valid data (DV1_VALID): t1, t3 and t4=high. t2 and t5=low. FIG. 5 is a diagram illustrating an exemplary sample “reconstructed” transport stream 500, according to an illustrative embodiment.

Referring to FIG. 4, an incoming transport stream is parsed by the parser 301 to identify any PIDs that are associated with the broadcast flag (step 410). The incoming transport stream is divided by the divider 301 to provide two streams there from, namely stream 1 and stream 2 (step 405). Stream 1 is also referred herein to as “MPTS-hbp” (hbp host by pass) and stream 2 is also referred to herein as “MPTS-hpi” (hpi=host pod interface).

All packets from stream 1 (MPTS-hbp) except those packets located on PIDs associated with the broadcast flag are removed from stream 1 by the non-BF packet remover 302 (step 415). The packets from stream 2 (MPTS-hpi) located on PIDs associated with the broadcast flag are stuffed (i.e., rendered unusable) by the BF packet stuffer 304 (step 420). The resulting stream 2 is sent to the POD 310 (step 425). The POD 310 may optionally process a selected virtual channel, if the selected virtual channel was scrambled with the matching proprietary network CA system (which, in this context, is noise) (step 430). Stream 2 is send from the POD 310 back to the host (step 432).

All BF flagged packets are removed from stream 2, by sending stream 2 from the POD 310 to the BF packet remover 312 (step 435).

The clock speed of both stream 1 (MPTS-hbp) and stream 2 (MPTS-hpi) are doubled by the clock speed doublers 306 and 314 (step 440). Packets from stream 1 (MPTS-hbp) and stream 2 (MPTS-hpi) are inserted into a bitstream to reconstruct the original MPTS, by the packet inserter (step 445). For example, the packet inserter 308 inserts a packet from the MPTS-hbp when the clock signal is odd and a packet from the MPTS-hpi when the signal is even. The reconstructed MPTS (outgoing MPTS) includes all packets to make up the full original MPTS, with the exception that the POD 310 might have processed a virtual channel when the one that was selected had been scrambled. It is to be appreciated that the packet inserter 308 will not insert a packet in the outgoing MPTS when there is no packet offered in the clock doubled input MPTS. It is to be further appreciated that an example of the process of packet insertion is further shown and described with respect to FIG. 5.

Channels of the type “fully clear”, “clear with BF enabled” or a channel that was re-scrambled by the POD CP scrambler are demultiplexed and/or descrambled (step 450).

It is to be appreciated that other clock speed increases other than doubling the clock speed may also be employed in accordance with the principles of the present invention, while maintaining the spirit of the present invention.

Moreover, it is to be appreciated that other data enablers different than that described herein and even the non-use of a data enabler may also be employed in accordance with the principles of the present invention, while maintaining the spirit of the present invention.

Further, it is to be appreciated that the stuffing of the packets with values other than FF or other approaches to making the packets otherwise unusable may also be employed in accordance with the principles of the present invention, while maintaining the spirit of the present invention.

Also, it is to be appreciated that the packet inserter can insert stuffed packets with FFFF (or another value) at the “empty” positions, as this will not disrupt operations of the demux, while maintaining the spirit of the present invention. It is to be further appreciated that other approaches to packet stuffing may also be employed while maintaining the spirit of the present invention.

FIG. 6 is a block diagram illustrating an apparatus 600 for controlling the distribution of data having an enabled broadcast flag (BF) associated therewith from a first device to a second device, according to yet another illustrative embodiment. FIG. 7 is a flow diagram illustrating a method 700 for controlling the distribution of data having an enabled broadcast flag (BF) associated therewith from a first device to a second device, according to yet another illustrative embodiment. FIG. 8 is a block diagram illustrating exemplary rules for the selector 612 shown and described with respect to FIG. 6, according to an illustrative embodiment.

Referring to FIG. 6, the first device is a host device (hereinafter “host”) 688 and the second device is a POD device (hereinafter “POD”) 699. The host 688 and the POD 699 are connected in signal communication with each other via a host POD interface 698. The POD 699 includes a POD descrambler 608, a POD CP scrambler 610, a POD OOB mac 626, and a POD CPU 634. The host 688 includes the remaining components. The apparatus 600 may be implemented in one or more of any of the elements of the POD 699 and the host 688, as described by the steps of the method of FIG. 7. Of course, the present invention is not limited to the elements and corresponding configuration (e.g., connections, and so forth) shown in FIG. 6 and, thus, other elements and configurations thereof may also be employed in accordance with the present invention while maintaining the spirit of the present invention. Various MPTS's 666 in various states/configurations are also shown in FIG. 6.

A first input of the host 688 is connected in signal communication with an input of a tuner 602. A second input of the host 688 is connected in signal communication with an input of a tuner 620. A first (RGB) output of the host 688 is connected in signal communication with a first output of the MPEG decoder 616. A second (audio) output of the host 688 is connected in signal communication with a second output of the MPEG decoder 616. The POD descrambler 608, the POD CP scrambler 610, the POD OOB mac 626, and the POD CPU 634 are included in a POD module (hereinafter “POD”) 699. The remaining components are included in a host module (hereinafter “host” 688). The POD 699 and the host 688 are connected in signal communication with each other via a host POD interface 698.

An output of the tuner 602 connected in signal communication with an input of a demodulator (QAM) 604. An output of the demodulator 604 is connected in signal communication with an input of a duplicator 606. A first output of the duplicator 606 is connected in signal communication with a first input of the POD descrambler 608. An output of the POD descrambler 608 is connected in signal communication with a first input of the POD CP scrambler 610. An output of the POD CP scrambler 610 is connected in signal communication with a first input of a selector 612. A second input of the selector 612 is connected in signal communication with a second output of the duplicator 606. An output of the selector 612 is connected in signal communication with a first input of a demultiplexer and descrambler 614. An output of the demultiplexer and descrambler 614 is connected in signal communication with an input of an MPEG decoder 616.

An output of the tuner 620 is connected in signal communication with an input of a demodulator (QPSKrx) 622. An output of the demodulator 622 is connected in signal communication with an input of a switch 624. An output of the switch 624 is connected in signal communication with an input of the POD OOB mac 626. A first output of the POD OOB mac 626 is connected in signal communication with a second input of the POD descrambler 608 and with a second input of the POD CP scrambler 610. A second output of the POD OOB mac 626 is connected in signal communication with an input of an OOB demultiplexer 628. An output of the OOB demultiplexer 628 is connected in signal communication with an input of program selection middleware 630. A first output of program selection middleware 630 is connected in signal communication with a host CPU 632. The host CPU 632 is connected in signal communication with the POD CPU 634. An output of the POD CPU 634 is connected in signal communication with a third input of the POD descrambler 608. An output of the host CPU 632 is connected in signal communication with an input of a POD CP 636. An output of the POD CP 636 is connected in signal communication with a second input of the demultiplexer and descrambler 614. A second output of the program selection middleware 630 is connected in signal communication with a third input of the demultiplexer and descrambler 614.

A control module A 677 is optionally connected in signal communication with the program selection middleware 630 and with the duplicator 606. A control module B 678 is connected in signal communication with the program selection middleware 630 and with the selector 612.

Further descriptions will now be given of the elements of FIG. 6 and their functions.

The present invention identifies the packets that are associated with a broadcast flag from the incoming Multi Program Transport Stream (MPTS-in) and “bans” those packets from the host pod interface 698.

The MPTS-in is duplicated by the duplicator 612 and the identical duplicate, referred to as MPTS-hbp, is sent over the host bypass channel 665 from the duplicator 606 to the selector 612.

At the same time, the duplicator 606 duplicates the MPTS-in to another MPTS-hpi, but makes the packets identified by an enabled broadcast flag unusable. The present invention removes the broadcast flagged packets, or stuffs those packets, or nulls those packets, or otherwise renders them unusable, inaccessible, and/or unavailable. This resulting MPTS-hpi is sent over the host pod interface 698 to the POD 699 to be processed. Further, sending MPTS-ses over the host bypass 665 and the host pod interface 698 at the same time is also encompassed by the present invention, since the POD standard currently requires a switch (e.g., switch 624) that sends the MPTS-in either via the host bypass or via the host pod interface.

After processing by the POD 699, the MPTS-hpi is transmitted back to the selector 612 in the host 688. The selector 612 allows a selection of the MPTS-hpi or the MPTS-hbp stream. The selection of one of the two streams is taken based on the selected virtual channel. If the selected virtual channel is in the clear with an enabled broadcast flag, then the MPTS-hbp is chosen. Otherwise, in the case when a clear virtual channel without a broadcast flag or a scrambled virtual channel is selected, then the MPTS-hpi is chosen. The completely clear virtual channels without an enabled broadcast flag could alternatively also be located in the MPTS-hbp. This stream based selection of the virtual channel is novel, since the POD standard currently requires a switch at the point where the signal paths from the MPTS traveling via the host bypass and the MPTS coming from the POD join and that is controlled based on whether or not a POD is present in the system. The inventive system selects either one of the two MPTS-ses that is offered via both available system paths.

In the case a POD module is absent, the host pod signal path is not used and hence the duplicator 606 will only create MPTS-hbp. In that situation, the selector 612 consequently cannot select the MPTS-hpi. It is also a feature that enhances the security that the system is able to refrain the MPTS-hpi from the host POD interface 698. The system first interprets the MPTS in order to know what broadcast flagged packets may not pass the host POD interface 698, and during this delay, the system will completely ban the MPTS-hpi from the host POD interface 698. It is to be appreciated that while the preceding is capable of being done, such action (complete banning) is optional and may not be performed because of, e.g., quicker responsiveness upon zapping outside a MPTS to a new MPTS.

A description will now be given with further regard to the duplicator 606, according to an illustrative embodiment of the present invention.

The incoming MPTS-in is “duplicated” after the demodulator 604 into two MPTS-ses. The duplicator 606 creates a MPTS (i.e., MPTS-hbp) that will travel via the host bypass. MPTS-hbp is identical to MPTS-in. The duplicator 606 creates a second MPTS (i.e., MPTS-hpi) that will cross the host pod interface 698 only when a real POD 699 is inserted into the host 688. The only difference to the MPTS-in is that all packets that are identified as broadcast flagged packets are null-ed in MPTS-hpi, for example with demux stuffing.

A description will now be given regarding detecting the BF flagged packets, according to an illustrative embodiment of the present invention.

To detect the BF flagged packets, the system needs to detect the “redistribution control” (RC) descriptor from the PMT table, (see, e.g., Advanced Television Systems Committee (ATSC) Standard: Program and System Information Protocol for Terrestrial Broadcast and Cable (Revision B), Doc. A/65B, Mar. 18, 2003.

The system starts opening a PID filter on PID equal to zero (PID=0x0000) to obtain the Program Allocation Table (PAT). The purpose of the PAT is to indicate, for each program (i.e. virtual channel) carried in the MPTS, the link between the program number (from 0 to 65535) and the PID of packets carrying a “map” of the program (program map table (PMT)).

In the MPTS there is one PMT present for each program (i.e. virtual channel). The PMT is always in the clear so it can indicate the PIDs of the elementary streams that belong to one program (i.e. virtual channel). The broadcaster high-handedly defines the PIDs where the PMTs are to be transported, taking into account some well defined exceptions and notifies the PIDs for the PMTs in the program allocation table (PAT). (Exceptions like 0x0000=PAT, 0x0001=CAT, etc.).

Each PMT must be parsed to check the value of the RC descriptor. Since events with an enabled broadcast flag can be followed by events with disabled broadcast flag this checking process must be performed continuously.

A description will now be given regarding banning the BF flagged packets, according to an illustrative embodiment of the present invention.

If the RC descriptor is enabled on a particular virtual channel, then all packets belonging to the elementary streams that make up this virtual channel must be “banned” as clear packets that can be tapped from the MPTS when it crosses the host POD interface. The idea should be that from a bandwidth perspective MPTS-in =MPTS-hbp=MPTS-hpi. With a demultiplexer capable of stuffing this is no problem (almost all demultiplexers are stuffing ones). The system will create PID filters for every elementary stream where the PMT states that the RC descriptor is enabled. Thus, next to stuffing the packets an alternative system removes the broadcast flagged packets in another way. For example completely removing those packets or null those packets or else.

It should be noted that, when a RC descriptor is enabled for a particular virtual channel, the ECMs on the PID as identified in the corresponding PMT will be passed to the POD. Some POD implementations rely on ECMs coming via the IB and when the POD cannot consume these messages the virtual channel cannot be decrypted.

In the case when the POD 699 is not inserted, the MPTS-hpi is not “duplicated” and consequently not available on the host POD interface 698.

In the case when the POD 699 is being inserted or in the case that the system (re)tunes to another frequency there is a delay caused by the system interpreting the PAT and PMT of the new MPTS in order to find the broadcast flagged packets (i.e. RC descriptor enabled) that must be banned. During this delay, the duplicator 606 will pass the MPTS-hbp with the complete stream via the host bypass 665 to the selector 612, but will not “duplicate” MPTS-hpi, so consequently there is no data available on the host POD interface. Only after the system completed the scan for the broadcast flagged packets the system will output the MPTS-hpi.

A description will now be given with further regard to the selector 612, according to an illustrative embodiment of the present invention.

When you zap to a BF-flagged channel you need to use MPTS-hbp. When you zap to a scrambled channel you need to use MPTS-hpi. When you zap to a fully clear channel, you may use either one. It is to be appreciated that two possible approaches are described herein: selecting the packets from MPTS-hbp or from MPTS-hpi′.

In one illustrative embodiment of the present invention, the selector 612 is a “switch” that selects one of the two MPTS-ses as MPTS-out to be sent to the host demultiplexer 614. The selector 612 needs some input when to switch from middleware (control module B 678), but the decision can be made based on existing PSIP info and/or channel maps. The selector 612 will switch under following two exemplary conditions.

In the first condition, the system changes the selected virtual channel from full clear or broadcast flagged to scrambled or vice versa according to the rules 800 shown and described with respect to FIG. 8. Some conditions must be true in order to be able to select scrambled content from MPTS-hpi (i.e., to order the POD 699 to process the selected scrambled virtual stream).

In the second condition, the POD 699 MUST be inserted and MPTS-hpi is actually duplicated. When the POD 699 is newly inserted or when the system (re)tunes to another frequency due to a zap outside the MPTS it takes some time before the MPTS has been interpreted. Duplication starts after the broadcast flag content of the new MPTS has been identified. The system signals that duplication MPTS-hpi has started so the selector can make a choice.

When flipping this selector switch 612, there is a delay because the MPTS-hbp and MPTS-hpi are not completely in sync. This will cause discontinuities but with a normal screen blank/unblank mechanism this is not noticeable.

The program selection middleware 630 may use, but is not limited to, the standard methods as outlined in the POD specification for deselecting and selecting the virtual channel to be descrambled. The program selection middleware 630 could additionally check the status of the duplicator 606 to know if the MPTS-hpi is (already) sent to the POD 699. With this information, the program selection middleware 630 could wait for the right moment before sending a command Ca_Pmt_cmd_id(Okdescrambling) to the POD 699. If sent to early when the MPTS-hpi is absent, this would just result in a time consuming Ca_Pmt_cmd_id(Query).

Referring to FIG. 7, an incoming Multi Program Transport. Stream (MPTS-in) is received (step 705). An input for selecting a particular virtual channel is received (step 710). Redistribution control, (RC) descriptors, if present, are detected in program map tables (PMTs) (step 715).

The MPTS-in is duplicated to provide a first duplicate (e.g., MPTS-hbp) and a second duplicate (e.g., MPTS-hpi) by the duplicator 606 (step 720). The first duplicate is an identical duplicate of the MPTS-in. The second duplicate is duplicated so that packets identified by the enabled BF are unusable. It is to be appreciated that all packets belonging to the elementary streams that make up the selected virtual channel are rendered unusable, when the RC descriptor is enabled in the selected virtual channel. The first duplicate is sent to the selector 612 in the first device (host 688) via the first device bypass route 665, and the second duplicate is sent to the second device (POD 699) via the interface 698 (step 725).

Both the first duplicate and the second duplicate are received from the second device by the selector 612 (step 730). A selection is made between only one of the first duplicate and the second duplicate by the selector 612, based on the selected virtual channel (step 735). In particular, the selector 612 selects the first duplicate when the selected virtual channel is a clear virtual channel with the enabled BF (step 735A), and the selector 612 selects the second duplicate when the selected virtual channel is a clear virtual channel without the enabled BF (step 735B). It is to be appreciated that the selector selects the first duplicate when the selected virtual channel is a clear virtual channel irrespective of whether the RC descriptor in the selected virtual channel is enabled or disabled.

The selector sends the selected one of the first duplicate or the second duplicate to a demultiplexer 614 in the first device (step 740). The demultiplexer 614 demultiplexes the selected one of the first duplicate or the second duplicate prior to decoding by, e.g., an MPEG decoder 616 (step 745).

Another alternative is to implement a remultiplexer functionality instead of the selector functionality, as shown and described with respect to FIGS. 9 and 10. This involves a complete re-multiplexing of the packets from the MPTS-hbp coming via the host bypass 665 and the MPTS-hpi coming from the POD pass through. From MPTS-hpi, all scrambled packets are selected, regardless of whether they are proprietary CA or POD CP scrambled. From MTPS-hbp, all clear and BF-flagged packets are selected. In yet another alternative: select the clear (i.e., non BF flagged) packets from MPTS-hpi. A complex buffer implementation synchronizes the delays between the MPTS-ses.

FIG. 9 is a block diagram illustrating an apparatus 900 for controlling the distribution of data having an enabled broadcast flag (BF) associated therewith from a first device to a second device, according to a further illustrative embodiment. FIG. 10 is a flow diagram illustrating a method 1000 for controlling the distribution of data having an enabled broadcast flag (BF) associated therewith from a first device to a second device, according to a further illustrative embodiment.

Referring to FIG. 9, the first device is a host device (hereinafter “host”) 988 and the second device is a POD device (hereinafter “POD”) 999. The host 988 and the POD 999 are connected in signal communication with each other via a host POD interface 998. The POD 999 includes a POD descrambler 908, a POD CP scrambler 910, a POD OOB mac 926, and a POD CPU 934. The host 988 includes the remaining components. The apparatus 900 may be implemented in one or more of any of the elements of the POD 999 and the host 988, as described by the steps of the method of FIG. 10. Of course, the present invention is not limited to the elements and corresponding configuration (e.g., connections, and so forth) shown in FIG. 9 and, thus, other elements and configurations thereof may also be employed in accordance with the present invention while maintaining the spirit of the present invention. Various MPTS's 966 in various states/configurations are also shown in FIG. 9.

A first input of the host 988 is connected in signal communication with an input of a tuner 902. A second input of the host 988 is connected in signal communication with an input of a tuner 920. A first (RGB) output of the host 988 is connected in signal communication with a first output of the MPEG decoder 916. A second (audio) output of the host 988 is connected in signal communication with a second output of the MPEG decoder 916. A POD descrambler 908, a POD CP scrambler 910, a POD OOB mac 926, and a POD CPU 934 are included in a POD module (hereinafter “POD”) 999. The remaining components are included in a host module (hereinafter “host” 988). The POD 999 and the host 988 are connected in signal communication with each other via a host POD interface 998.

An output of the tuner 902 connected in signal communication with an input of a demodulator (QAM) 904. An output of the demodulator 904 is connected in signal communication with an input of a divider 906. A first output of the divider 906 is connected in signal communication with a first input of the POD descrambler 908. An output of the POD descrambler 908 is connected in signal communication with a first input of the POD CP scrambler 910. An output of the POD CP scrambler 910 is connected in signal communication with a first input of a joiner 912. A second input of the joiner 912 is connected in signal communication with a second output of the divider 906. An output of the joiner 912 is connected in signal communication with a first input of a demultiplexer and descrambler 914. An output of the demultiplexer and descrambler 914 is connected in signal communication with an input of an MPEG decoder 916.

An output of the tuner 920 is connected in signal communication with an input of a demodulator (QPSKrx) 922. An output of the demodulator 922 is connected in signal communication with an input of a switch 924. An output of the switch 924 is connected in signal communication with an input of the POD OOB mac 926. A first output of the POD OOB mac 926 is connected in signal communication with a second input of the POD descrambler 908 and with a second input of the POD CP scrambler 910. A second output of the POD OOB mac 926 is connected in signal communication with an input of an OOB demultiplexer 928. An output of the OOB demultiplexer 928 is connected in signal communication with an input of program selection middleware 930. A first output of program selection middleware 930 is connected in signal communication with a host CPU 932. The host CPU 932 is connected in signal communication with the POD CPU 934. An output of the POD CPU 934 is connected in signal communication with a third input of the POD descrambler 908. An output of the host CPU 932 is connected in signal communication with an input of a POD CP 936. An output of the POD CP 936 is connected in signal communication with a second input of the demultiplexer and descrambler 914. A second output of the program selection middleware 930 is connected in signal communication with a third input of the demultiplexer and descrambler 914.

A control module A 977 is connected in signal communication with the program selection middleware 930 and with the divider 906. A control module B 978 is connected in signal communication with the program selection middleware 930 and with the joiner 912.

Referring to FIG. 10, an incoming transport stream is parsed to identify the PIDs, if any, that are associated with the broadcast flag, by the program selection middleware 930 or some other self contained entity (step 1005). It is to be appreciated that, in general, the program selection middleware 930 always uses the host demultiplexer and mostly runs on the host CPU, but other implementations may also be employed as readily determined by one of ordinary skill in the related art. For example, the program selection middleware 930 may be implemented on a separate chip (e.g., with a separate CPU), so that there is no interaction with the host or host demultiplexer or program selection middleware. This is also true for elements 677 and 978 in FIGS. 6 and 9, respectively.

The incoming transport stream is divided by the divider 906 to provide two streams there from, namely stream 1 and stream 2 (step 1010). Stream 1 is also referred herein to as “MPTS-hbp” (hbp=host by pass) and stream 2 is also referred to herein as “MPTS-hpi” (hbp=host by pass). MPTS-hpi will be set over the host pod interface 998 to the POD 999.

All packets from stream 1 (MPTS-hbp) except those located on PIDs associated with the broadcast flag are stuffed (rendered unusable) (step 1015). All of the packets from stream 2 (MPTS-hpi) located on PIDs that are associated with the broadcast flag are stuffed (rendered unusable) (step 1020).

The resulting transport stream is sent to the POD 999 (step 1025). The POD 999 may process a selected virtual channel, if the selected virtual channel was scrambled with the matching proprietary network CA system (which, in this context, is noise) (step 1030). The transport stream is sent back to the host 988 (step 1032).

Packets from the MPTS-hbp and the MPTS-hpi are input to the joiner 912 and selected thereby based on predetermined criteria (step 1035). For example, the joiner 912 will use packets from the MPTS-hbp when those packets belong to a PID that is associated with a broadcast flag, as was identified by the divider 906. Further, the joiner 912 will use packets from the MPTS-hpi when those packets belong to a PID that is not identified as being associated with a broadcast flagged PID.

The joiner 912 remultiplexes the selected packets into a new MPTS that is send to the host demultiplexer and descrambler 914 (step 1040). The reconstructed MPTS includes all of the packets needed to reconstruct the original MPTS, with the exception that the POD 999 may have processed a virtual channel when the channel that was selected had been scrambled. The demultiplexer and descrambler 914 demultiplexes and/or unscrambles channels of the type “fully clear”, “clear with BF enabled”, or a channel that was re-scrambled by the POD CP scrambler 910 (step 1045).

These and other features and advantages of the present disclosure may be readily ascertained by one of ordinary skill in the pertinent art based on the teachings herein. It is to be understood that the teachings of the present disclosure may be implemented in various forms of hardware, software, firmware, special purpose processors, or combinations thereof.

Most preferably, the teachings of the present disclosure are implemented as a combination of hardware and software. Moreover, the software is preferably implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present invention is programmed. Given the teachings herein, one of ordinary skill in the pertinent art will be able to contemplate these and similar implementations or configurations of the present invention.

Although the illustrative embodiments have been described herein with reference to the accompanying drawings, it is to be understood that the present disclosure is not limited to those precise embodiments, and that various changes and modifications may be effected therein by one of ordinary skill in the pertinent art without departing from the scope or spirit of the present invention. All such changes and modifications are intended to be included within the scope of the present disclosure as set forth in the appended claims.

What is claimed is:

1. An apparatus for controlling distribution of data from a first device to a second device, comprising:
a broadcast flag detector for detecting one or more portions of the data associated with an enabled broadcast flag (BF); and
a data manipulation device (106) for manipulating the one or more portions so as to render the one or more portions of the data useable in the first device only upon further manipulation and so as to render the one or more portions of the data permanently unusable in the second device.

2. The apparatus of claim 1, wherein said data manipulation device (106) renders the one or more portions of the data permanently unusable by at least one of scrambling, shifting, stuffing with pre-determines values, XOR-ing, hiding, deleting, and nullifying.

3. The apparatus of claim 1, wherein the first device includes a demultiplexer, the apparatus further comprises another data manipulation device for at least performing the further manipulation and for providing the further manipulated data to the demultiplexer, and said data manipulation device comprises:
a scrambler (106) for scrambling the one or more portions of the data so that the one or more portions of the data can be unscrambled by the other manipulation device and so that the one or more portions of the data cannot be unscrambled in the second device; and
a de-scrambler (112) for unscrambling only the one or more portions of the data for use by the demultiplexer.

4. The apparatus of claim 3, wherein said data manipulation device and said other data manipulation device are comprised in the first device.

5. The apparatus of claim 3, wherein said scrambler (106) scrambles packet identifiers (PIDs) for the one or more portions of the data associated with the enabled broadcast flag.

6. The apparatus of claim 5, further comprising a PID determination device for determining the PIDs for the one or more portions of the data associated with the enabled broadcast flag by parsing program map tables (PMTs) in the data to find any redistribution control (RC) descriptors therein.

7. An apparatus for controlling distribution of data from a first device to a second device, the apparatus comprising:
a divider (301) for dividing the incoming bitstream into at least a first bitstream and a second bitstream;
a data manipulation device for removing, from the first bitstream, packets not located on packet identifiers (PIDs) associated with an enabled broadcast flag (BF), and for manipulating, from the second bitstream, other packets located on the PIDs associated with the enabled BF so as to render the manipulated packets unusable; and
a clock speed increaser (306) for increasing a clock speed between the first device and the second device,
wherein said data manipulation device inserts at least some remaining packets from the first bitstream and the second bitstream, respectively, into a reconstructed bitstream that reconstructs the incoming bitstream for sending to the second device, wherein the at least some of the remaining packets are inserted at intervals corresponding to the increased clock speed.

8. The apparatus of claim 7, wherein said data manipulation device renders the manipulated packets unusable by at least one of scrambling, shifting, stuffing with pre-determines values, XOR-ing, hiding, deleting, and nullifying.

9. The apparatus of claim 7, wherein the first device has a demultiplexer for demultiplexing the data, the second device has a controller, and said clock speed increaser (306) doubles the clock speed between the controller and the demultiplexer.

10. The apparatus of claim 9, further comprising a data enable signal generator for generating a data enable signal for the demultiplexer that reduces a hardware interrupt request load level to a pre enabled broadcast flag condition.

11. The apparatus of claim 7, further comprising a BF detector for detecting, in the incoming bitstream, the PIDs associated with the enabled BF.

12. An apparatus for controlling data distribution from a first device to a second device, comprising:
a broadcast flag detector for detecting one or more data packets associated with an enabled broadcast flag (BF) from within an incoming bitstream;
a duplicator (606) for receiving and duplicating the incoming bitstream to provide a first duplicate and a second duplicate of the incoming bitstream, the first duplicate being an identical duplicate of the incoming bitstream, the second duplicate being duplicated so that packets identified by the enabled BF are unusable, said duplicator further for sending the second duplicate to the second device; and
a selector (612), operatively coupled to said duplicator, for receiving both the first duplicate and the second duplicate from the second device and for selecting only one of the first duplicate and the second duplicate based on a selected virtual channel.

13. The apparatus of claim 12, wherein the first device includes a first device bypass channel, and said duplicator (606) is further for sending the first duplicate to said selector via the first device bypass channel.

14. The apparatus of claim 12, wherein said selector (612) selects the first duplicate when the selected virtual channel is a clear virtual channel associated with the enabled BF, and said selector selects the second duplicate when the selected virtual channel is the clear virtual channel not associated with the enabled BF.

15. The apparatus of claim 12, wherein the first device includes a demultiplexer, and said selector (612) sends the selected one of the first duplicate and the second duplicate to the demultiplexer.

16. The apparatus of claim 12, further comprising a redistribution control (RC) descriptor detector for detecting an RC descriptor from a program map table (PMT) table.

17. The apparatus of claim 16, wherein all packets belonging to elementary streams that make up the selected virtual channel are rendered unusable, when the RC descriptor is enabled in the selected virtual channel.

18. The apparatus of claim 16, wherein the selector (612) selects the first duplicate when any one of the selected virtual channel is a clear virtual channel having a disabled RC descriptor and the selected virtual channel is a clear virtual channel having an enabled RC descriptor, and the selector selects the second duplicate when the selected virtual channel when the selected virtual channel is a scrambled virtual channel.

19. The apparatus of claim 12, wherein the incoming bitstream is a Multi Program Transport Stream.

20. An apparatus for controlling distribution of data from a first device to a second device, the apparatus comprising:
a divider (906) for dividing an incoming bitstream into at least a first stream and a second stream;
a data manipulation device for rendering unusable, from the first bitstream, packets not located on packet identifiers (PIDs) associated with an enabled broadcast flag (BF), and for rendering unusable, from the second bitstream, other packets located on the PIDs associated with the enabled BF;
a joiner (912) for selecting remaining packets from the first bitstream and the second bitstream to form another bitstream that is a reconstruction of the incoming bitstream for sending to the second device, wherein the remaining packets selected from the first bitstream are respectively located on a PID associated with the enabled BF and the remaining packets selected from the second bitstream are respectively located on a PID not associated with the enabled BF.

21. The apparatus of claim 20, wherein said data manipulation device renders the packets and the other packets unusable by at least one of scrambling, shifting, stuffing with pre-determines values, XOR-ing, hiding, deleting, and nullifying.

22. The apparatus of claim 20, further comprising a broadcast flag detector for detecting the one or more data packets associated with the enabled broadcast flag (BF) from within the incoming bitstream.

23. The apparatus of claim 20, wherein the incoming bitstream is a Multi Program Transport Stream.

24. In a first device, a method for controlling distribution of data from the first device to a second device, comprising the steps of:
detecting (205) one or more portions of the data associated with an enabled broadcast flag (BF); and
manipulating (210) the one or more portions so as to render the one or more portions of the data useable in the first device only upon further manipulation and so as to render the one or more portions of the data permanently unusable in the second device.

25. The method of claim 24, wherein said manipulating step (210) renders the one or more portions of the data permanently unusable by at least one of scrambling, shifting, stuffing with predetermines values, XOR-ing, hiding, deleting, and nullifying.

26. The method of claim 24, wherein the first device includes a demultiplexer, the method further comprises the steps of:
performing the further manipulation in the first device;
providing the further manipulated data to the demultiplexer, and
wherein said manipulating step comprises the steps of:
scrambling the one or more portions of the data so that the one or more portions of the data can be unscrambled in the first device and so that the one or more portions of the data cannot be unscrambled in the second device; and
unscrambling only the one or more portions of the data for use by the demultiplexer.

27. The method of claim 26, wherein said scrambling step scrambles packet identifiers (PIDs) for the one or more portions of the data associated with the enabled broadcast flag.

28. The method of claim 27, further comprising the step of determining the PIDs for the one or more portions of the data associated with the enabled broadcast flag by parsing program map tables (PMTs) in the data to find any redistribution control (RC) descriptors therein.

29. A program storage device readable by machine, tangibly embodying a program of instructions executable by the machine to perform method steps for controlling distribution of data from a first device to a second device as recited in claim 24.

30. In a first device, a method for controlling distribution of data from the first device to a second device, comprising the steps of:
dividing (410) the incoming bitstream into at least a first bitstream and a second bitstream;
removing (415), from the first bitstream, packets not located on packet identifiers (PIDs) associated with an enabled broadcast flag (BF), and for manipulating, from the second bitstream, other packets located on the PIDs associated with the enabled BF so as to render the manipulated packets unusable; and
increasing (440) a clock speed between the first device and the second device,
inserting (445) at least some remaining packets from the first bitstream and the second bitstream, respectively, into a reconstructed bitstream that reconstructs the incoming bitstream for sending to the second device, wherein the at least some of the remaining packets are inserted at intervals corresponding to the increased clock speed.

31. The method of claim 30, wherein said manipulating step renders the manipulated packets unusable by at least one of scrambling, shifting, stuffing with pre-determines values, XOR-ing, hiding, deleting, and nullifying.

32. The method of claim 30, wherein the first device has a demultiplexer for demultiplexing the data, the second device has a controller, and said increasing step (440) doubles the clock speed between the controller and the demultiplexer.

33. The method of claim 32, further comprising the step of generating a data enable signal for the demultiplexer that reduces a hardware interrupt request load level to a pre enabled broadcast flag condition.

34. The method of claim 30, further comprising the step of detecting, in the incoming bitstream, the PIDs associated with the enabled BF.

35. A program storage device readable by machine, tangibly embodying a program of instructions executable by the machine to perform method steps for controlling distribution of data from a first device to a second device as recited in claim 30.

36. In a first device, a method for controlling data distribution from the first device to a second device, comprising the steps of:
detecting (715) one or more data packets associated with an enabled broadcast flag (BF) from within an incoming bitstream;
receiving and duplicating (720) the incoming bitstream to provide a first duplicate and a second duplicate of the incoming bitstream, the first duplicate being an identical duplicate of the incoming bitstream, the second duplicate being duplicated so that packets identified by the enabled BF are unusable;
sending (725) the second duplicate to the second device; and
receiving (730) both the first duplicate and the second duplicate from the second device and selecting (735) only one of the first duplicate and the second duplicate based on a selected virtual channel.

37. The method of claim 36, wherein said selecting step (735) selects the first duplicate when the selected virtual channel is a clear virtual channel associated with the enabled BF, and said selecting step selects the second duplicate when the selected virtual channel is the clear virtual channel not associated with the enabled BF.

38. The method of claim 36, wherein the first device includes a demultiplexer, and said selecting step (735) sends the selected one of the first duplicate and the second duplicate to the demultiplexer.

39. The method of claim 36, further comprising the step of detecting a redistribution control (RC) descriptor from a program map table (PMT) table.

40. The method of claim 39, wherein all packets belonging to elementary streams that make up the selected virtual channel are rendered unusable, when the RC descriptor is enabled in the selected virtual channel.

41. The method of claim 39, wherein the selecting step (735) selects the first duplicate when any one of the selected virtual channel is a clear virtual channel having a disabled RC descriptor and the selected virtual channel is a clear virtual channel having an enabled RC descriptor, and the selector selects the second duplicate when the selected virtual channel when the selected virtual channel is a scrambled virtual channel.

42. The method of claim 36, wherein the incoming bitstream is a Multi Program Transport Stream.

43. A program storage device readable by machine, tangibly embodying a program of instructions executable by the machine to perform method steps for controlling data distribution from a first device to a second device as recited in claim 36.

44. In a first device, a method for controlling distribution of data from the first device to a second device, comprising the steps of:
dividing (1010) an incoming bitstream into at least a first stream and a second stream;
rendering unusable (1015), from the first bitstream, packets not located on packet identifiers (PIDs) associated with an enabled broadcast flag (BF), and rendering unusable (1020), from the second bitstream, other packets located on the PIDs associated with the enabled BF;
selecting (1035) remaining packets from the first bitstream and the second bitstream to form another bitstream that is a reconstruction of the incoming bitstream for sending to the second device, wherein the remaining packets selected from the first bitstream are respectively located on a PID associated with the enabled BF and the remaining packets selected from the second bitstream are respectively located on a PID not associated with the enabled BF.

45. The method of claim 44, wherein said rendering step renders the packets and the other packets unusable by at least one of scrambling, shifting, stuffing with pre-determines values, XOR-ing, hiding, deleting, and nullifying.

46. The method of claim 44, further comprising the step of detecting the one or more data packets associated with the enabled broadcast flag (BF) from within the incoming bitstream.

47. The method of claim 44, wherein the incoming bitstream is a Multi Program Transport Stream.

48. A program storage device readable by machine, tangibly embodying a program of instructions executable by the machine to perform method steps for controlling distribution of data from a first device to a second device as recited in claim 44.
